(19) United States
(12) Patent Application Publication
(10) Pub. No.: US 2012/0034883 A1
(43) Pub. Date: Feb. 9, 2012

(54) WIRELESS TRANSCEIVER

(75) Inventors: KUAN-CHUAN CHOU, Tu-Cheng (TW); HSUAN-TA CHOU, Tu-Cheng (TW)

(73) Assignee: HON HAI PRECISION INDUSTRY CO., LTD., Tu-Cheng (TW)

(21) Appl. No.: 12/875,136

(22) Filed: Sep. 3, 2010

(30) Foreign Application Priority Data
Aug. 3, 2010 (CN) 201010243701.X

(51) Int. Cl. H04B 1/44

(52) U.S. Cl. 455/83

(57) ABSTRACT

A wireless transceiver comprises an antenna, a switch, a first receiver amplifier, a second receiver amplifier, a transmitter, a receiver, and a signal processor. The switch connects to the antenna and the transmitter respectively. The second receiver amplifier connects to the first receiver amplifier via the receiver. The signal processor connects to the first receiver amplifier and the second receiver amplifier respectively and controls working modes of the first receiver amplifier and the second receiver amplifier.

### BACKGROUND

1. Technical Field

The present disclosure relates to a wireless transceiver for a portable device.

2. Description of Related Art

Portable devices such as mobile phones, personal digital assistants (PDA) and laptop computers are widely used. Transceivers are installed in such portable devices to receive/send wireless signals. Generally, the transceivers may magnify received wireless signals with an amplifier. However, most transceivers are insensitive to the received wireless signals so that magnitude of the received wireless signals are out of a proper working range of the amplifier. Communication quality of the portable devices may be affected.

### BRIEF DESCRIPTION OF THE DRAWINGS

Aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding sections throughout the figures.

FIG. 1 is a block diagram of one embodiment of a wireless transceiver.

FIG. 2 is a measurement diagram of one embodiment of the wireless transceiver of FIG. 1.

### DETAILED DESCRIPTION

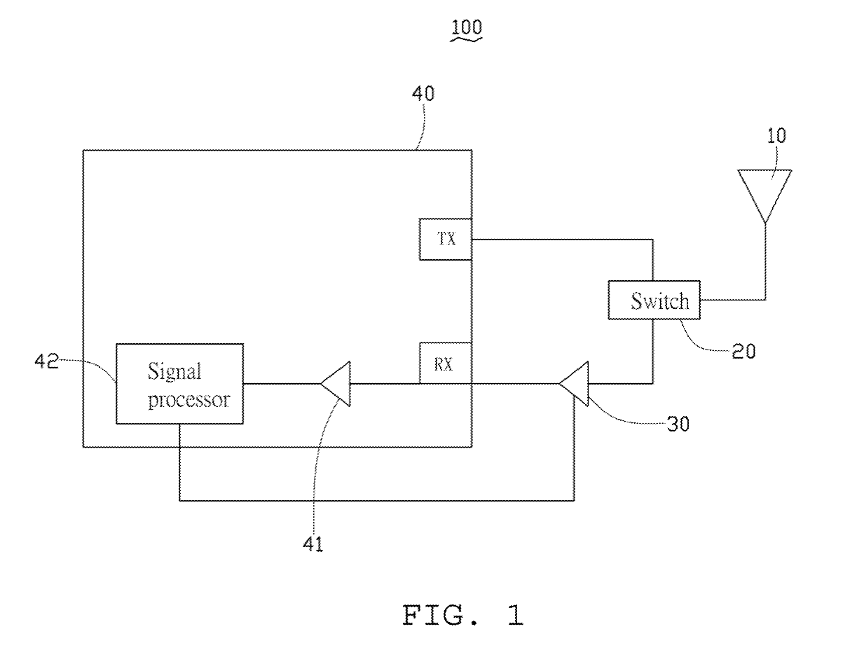

FIG. 1 a block diagram of one embodiment of a wireless transceiver 100. The wireless transceiver 100 comprises an antenna 10, a switch 20, a first receiver amplifier 30, and a transceiver module 40. The antenna 10 connects to the switch 20. The transceiver module 40 directly connects to the switch 20 at one end, and connects to the switch 20 via the first receiver amplifier 30 at the other. The antenna 10 transmits/receives radio signals. The switch 20 determines if the antenna 10 is in a transmission or reception mode.

The transceiver module 40 comprises a transmitter TX, a receiver RX, a second receiver amplifier 41, and a signal processor 42. The transmitter TX connects to the switch 20 forming a path for signal transmission from the transmitter TX, through the switch 20, to the antenna 10. The second receiver amplifier 42 connects to the first receiver amplifier 30 via the receiver RX at one end, and connects to the signal processor 42 at the other, forming a path for signal reception from the antenna 10, through the first receiver amplifier 30, the receiver RX, the second receiver amplifier 30, to the signal processor 42.

The signal processor 42 further connects to the first receiver amplifier 30 so that the signal processor 42 can adjust one or more working modes of the first receiver amplifier 30 and the second receiver amplifier 41, according to a comparison of a threshold pre-set in the signal processor 42 with received radio signals (hereinafter “sensitivity”). In the embodiment, the first receiver amplifier 30 and the second receiver amplifier 41 are low noise amplifiers providing a bypass mode and a gain mode, where the bypass mode is a low-gain mode, and the gain mode is a high-gain mode.

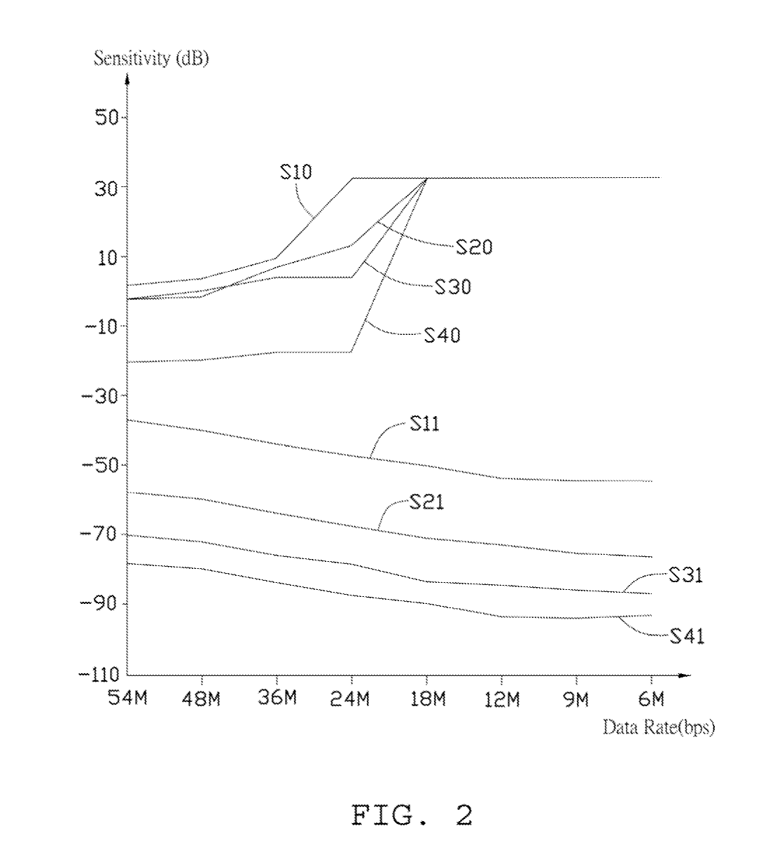

FIG. 2 is a measurement diagram of one embodiment of the wireless transceiver of FIG. 1. When the first receiver amplifier 30 operates in the bypass mode and the second receiver amplifier 41 operates in the bypass mode, the sensitivity of the wireless transceiver 100 is in a first range. Curve S10 and S11 represent a maximum and a minimum value of the first range respectively. When the first receiver amplifier 30 operates in the gain mode and the second receiver amplifier 41 operates in the bypass mode, the sensitivity of the wireless transceiver 100 is in a second range. Curves S20 and S21 represent a maximum and a minimum value of the second range respectively. When the first receiver amplifier 30 operates in the bypass mode and the second receiver amplifier 41 operates in the gain mode, the sensitivity of the wireless transceiver 100 is in a third range. Curves S30 and S31 represent a maximum and a minimum value of the third range respectively. When the first receiver amplifier 30 operates in the gain mode and the second receiver amplifier 41 operates in the gain mode, the sensitivity of the wireless transceiver 100 is in a fourth range. Curve S40 and S41 represent a maximum and a minimum value of the fourth range respectively.

In the embodiment, the first range overlaps the fourth range, such that an upper boundary of the fourth range exceeds a lower boundary of the first range. A difference of the upper boundary of the fourth range and the lower boundary of the first range is no less than 10 dB.

It is understood that the signal processor 42 controls the sensitivity of the wireless transceiver 100 by adjusting the one or more working modes of the first receiver amplifier 30 and the second receiver amplifier 41. For example, the signal processor 42 alters the sensitivity of the wireless transceiver 100 from the first range to the third range by switching the second receiver amplifier 41 from the bypass mode to the gain mode. In the embodiment, the threshold used to define the sensitivity of the wireless transceiver 100 is half of a sum of S11 and S40.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent, indicated by the broad general meaning of the terms in which the appended claims are expressed.

What is claimed is:

1. A wireless transceiver, comprising:
an antenna;
a switch;
a first receiver amplifier; and
a transceiver module comprising a transmitter and a receiver, wherein the switch connects to the antenna and to the transmitter , wherein the transceiver module further comprises a second receiver amplifier connected to the first receiver amplifier via the receiver, and a signal processor connected to the first receiver amplifier and to the second receiver amplifier, wherein the signal processor controls one or more working modes of the first receiver amplifier and of the second receiver amplifier.

2. The device as claimed in claim 1, wherein the one or more working modes of the first receiver amplifier and the second receiver amplifier comprise a bypass mode and a gain mode, wherein sensitivity of the device is in a first range if the first receiver amplifier is in the bypass mode and the second receiver amplifier is in the bypass mode, the sensitivity of the device is in a second range if the first receiver amplifier is in the gain mode and the second receiver amplifier is in the bypass mode, wherein the sensitivity of the device is in a third range if the first receiver amplifier is in the bypass mode and the second receiver amplifier is in the gain mode, wherein the sensitivity of the device is in a fourth range if the first receiver amplifier is in the gain mode and the second receiver amplifier is in the gain mode.

3. The device as claimed in claim 2, wherein the signal processor compares received signals from the receiver with a threshold, and adjusts the one or more working modes of the first receiver amplifier and of the second receiver amplifier accordingly.

4. The device as claimed in claim 3, wherein the threshold is within a range overlapped by the first range and the fourth range.

5. The device as claimed in claim 3, wherein the threshold is half of a sum of a lower boundary of the first range and a upper boundary of the fourth range.

6. The device as claimed in claim 5, wherein a difference of the lower boundary of the first range and the upper boundary of the fourth range is no less than 10 dB.
